(19) United States
(12) Patent Application Publication
(10) Pub. No.: US 2017/0372085 A1
(43) Pub. Date: Dec. 28, 2017

(54) PROTECTING DATA IN A STORAGE DEVICE

(71) Applicant: HGST Netherlands B.V., Amsterdam (NL)

(72) Inventors: Collin HOWE, Rochester, MN (US); Colin McCAMBRIDGE, Rochester, MN (US); Adam GEML, Rochester, MN (US)

(21) Appl. No.: 15/195,371

(22) Filed: Jun. 28, 2016

(51) Int. Cl. G06F 21/62; G06F 21/78; H04L 9/08

(52) U.S. Cl. CPC G06F 21/62; H04L 9/0897; G06F 21/78; H04L 9/0861

(57) ABSTRACT

A first data encryption key is stored on a storage device. The first data encryption key, a first key encryption key obtained from first information received from a host system, and second information that is received from a source other than the host system are used to generate a second data encryption key that can be used to encrypt and decrypt data stored on the storage device. The second information may be sent from the source to the storage device only if a condition is satisfied.

### BACKGROUND

Maintaining the security of stored data (“data-at-rest”) is important and of increasing concern as attacks become more sophisticated. Today, organizations are susceptible to insider as well as outsider attacks. Storage device manufacturers and storage service providers are expected to have security measures in place to protect stored data in the event of an attack from an unauthorized third party, including insiders. Perimeter security can protect against outside attacks but does not account for internal threats, and thus other mechanisms are needed to protect against inside attackers.

Contemporary storage devices include mechanisms for protecting the data stored on them by encrypting that data using a data encryption key that is generated internally by the storage device using a high-quality random number generator. The data encryption key is protected using a key encryption key that is also generated internally by the storage device. For example, the storage device receives a security key (e.g., a password) from a host system and passes the key through a key derivation function such as PBKDF2 (Password-Based Key Derivation Function 2) to derive the key encryption key. The key encryption key is used with a key wrapping algorithm such as the National Institute of Standards and Technology (NIST) Advanced Encryption Standard (AES) algorithm to securely wrap the data encryption key. The encrypted data and the wrapped data encryption key are stored on the storage device. When the stored data is subsequently retrieved, the wrapped data encryption key is unwrapped by the key wrapping algorithm using the security key, and the unwrapped data encryption key is then used to decrypt the data.

One type of attack occurs by compromising the host system and extracting its security key (e.g., password). Another type of attack occurs by compromising the firmware on the storage device, allowing the storage device to capture and store the host system's security key during a normal firmware-mediated authentication process. These types of attacks can be initiated from the inside or from the outside. Once the security key is extracted or exposed, an inside attacker can remove the storage device from the data center. The security key can then be used with the key derivation function and the key wrapping algorithm on the storage device to determine the data encryption key and decrypt the stored data.

### SUMMARY

Embodiments according to the disclosed invention strengthen the security of a data encryption key used to encrypt and decrypt data-at-rest and thus strengthen the security of that data. In order to derive the data encryption key and decrypt the data, embodiments according to the invention utilize at least one additional authentication factor relative to conventional approaches. Furthermore, in other embodiments according to the invention, the additional authentication factor(s) are not given to the storage device unless it is demonstrated that at least one condition is satisfied. A condition can be specified such that the storage device is locked or bound to a particular location, so that the storage device is prevented from operating if it is not at or within acceptable range of that location. A condition can be specified such that the storage device is locked or bound to a specific person or persons, so that the storage device is prevented from operating for any user except the authorized user(s). Note these conditions apply to situations in which the storage device is part of another device such as a laptop and the other device (including the storage device) is removed from its proper location or in which an unauthorized person attempts to operate the other device.

In overview, a “first data encryption key” is stored on a storage device. The first data encryption key, a “first key encryption key” obtained from “first information” received from a host system, and “second information” (an additional, second authentication factor) that is received from a source (“second source”) other than the host system are used to generate a final data encryption key (“second data encryption key”) that can be used to encrypt and decrypt data stored on the storage device.

In an embodiment, a wrapped version of the first data encryption key is unwrapped using the first key encryption key, thereby generating an intermediary version of the data encryption key. The second data encryption key is generated using the intermediary version of the data encryption key in combination with the second information that is received from the second source.

Thus, a second authentication factor (the second information) is used in addition to the authentication factor (the first information) that is based on the security key (e.g., password). The use of the second authentication factor as disclosed herein strengthens the security of the data encryption key and hence the security of the stored data.

Furthermore, in an embodiment, the second authentication factor is provided only if one or more conditions are satisfied. The condition may be based on, for example, the location of the storage device, the presence of a particular physical object, or the environment of the storage device, or a combination of conditions. Thus, for example, the condition(s) guard against removal of the storage device from the host system or data center; if the storage device is removed, then one or more of the conditions cannot be satisfied. If the one or more conditions are not all satisfied, then the second information is not sent to the storage device, the second data encryption key cannot be generated, and the stored data cannot be decrypted. Because of the need to satisfy the condition(s) in order to receive additional information (the second information) that is needed to derive the data encryption key and decrypt the data, the storage device is protected against being removed and tampered with by, for example, an inside attacker.

In an embodiment, the second data encryption key (which is used to encrypt and decrypt data stored on the storage device) is generated by a key generator (e.g., a random number generator). In an embodiment, the second information (second authentication factor) received from the second source includes a “second key encryption key.” The second data encryption key is wrapped by the first key encryption key (generated using the host system security key) and by the second key encryption key to generate a wrapped version of the first data encryption key. The wrapped first data encryption key can then be stored on the storage device. To retrieve the second data encryption key (in order to encrypt and/or decrypt data), the wrapped first data encryption key is accessed and unwrapped using the first key encryption key and using the second key encryption key. In an embodiment, as noted above, the second key encryption key is provided by the second source only if one or more conditions are all satisfied.

In another embodiment, the second data encryption key that is generated by the key generator is divided into a first share and a second share. The first share is wrapped with the first key encryption key to generate a wrapped version of the first data encryption key, which can then be stored on the storage device. The second share is stored on the second source. The second information received from the second source includes the second share of the second data encryption key. To retrieve the second data encryption key (which is used to encrypt and decrypt data stored on the storage device), the wrapped first data encryption key is unwrapped with the first key encryption key to generate the first share of the second data encryption key, and the first share and the second share are combined to generate the second data encryption key. In an embodiment, as noted above, the second share is provided by the second source only if one or more conditions are all satisfied.

In yet another embodiment, the data encryption key that is generated by the key generator is wrapped with the first key encryption key to generate a wrapped version of the first data encryption key, which can then be stored on the storage device. The second information received from the second source includes a “third data encryption key.” To retrieve the second data encryption key (which is used to encrypt and decrypt data stored on the storage device), the wrapped first data encryption key is unwrapped with the first key encryption key, and the result is combined with the third data encryption key to generate the second data encryption key. In an embodiment, as noted above, the third data encryption key is provided by the second source only if one or more conditions are all satisfied.

In summary, embodiments according to the present invention enhance security measures for protecting data-at-rest in scenarios where the host system becomes compromised and/or has its security keys extracted by an attacker, or in scenarios where the storage device is compromised by malicious firmware that captures and stores the host system's security keys, and then the storage device is removed from the host system or data center. Embodiments according to the invention guard against these scenarios using a second authentication factor that provides an added level of security against both inside and outside attacks. In other embodiments, the second authentication factor is not given to the storage device if one or more conditions are not satisfied, providing yet another level of security.

These and other objects and advantages of the various embodiments according to the present invention will be recognized by those of ordinary skill in the art after reading the following detailed description of the embodiments that are illustrated in the various drawing figures.

### BRIEF DESCRIPTION OF DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 is a block diagram showing elements of a storage system upon which embodiments according to the present invention can be implemented.

FIG. 2 is a block diagram of a two-factor authentication storage device in embodiments according to the present invention.

FIG. 3 is a block diagram of a two-factor authentication storage device in an embodiment according to the present invention.

FIG. 4 is a block diagram of a two-factor authentication storage device in another embodiment according to the present invention.

FIG. 5 is a block diagram of a two-factor authentication storage device in yet another embodiment according to the present invention.

FIG. 6 is a block diagram illustrating how condition(s) for authenticating the location of the storage device can be established and applied through the use of location awareness and detection in embodiments according to the invention.

FIG. 7 is a block diagram illustrating how condition(s) for authenticating the location of the storage device can be established and applied through the use of passive environmental characterization in embodiments according to the invention.

FIG. 8 is a block diagram illustrating how condition(s) for authenticating the location of the storage device can be established and applied through the use of a physical component or object in embodiments according to the invention.

FIGS. 9, 10, 11, and 12 are flowcharts illustrating examples of operations for protecting data in a storage device in embodiments according to the present invention.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

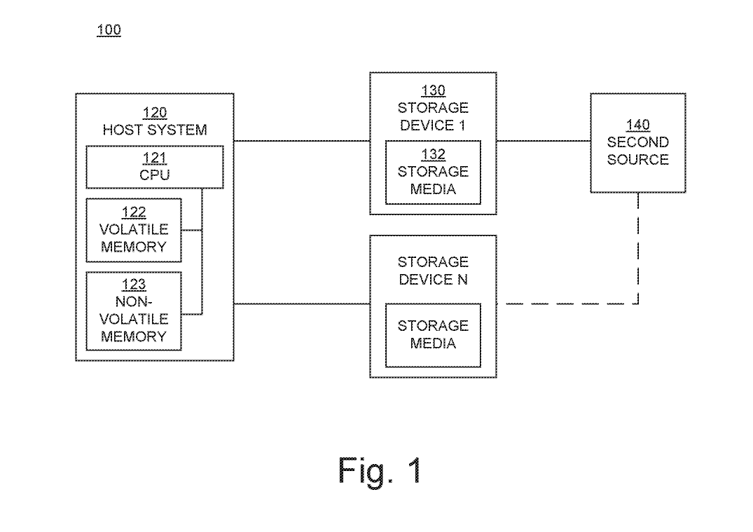

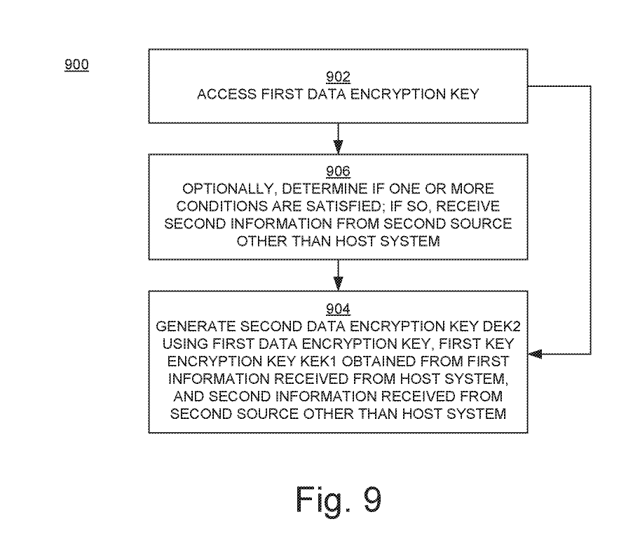

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “receiving,” “accessing,” “sending,” “wrapping,” “unwrapping,” “generating,” “encrypting,” “decrypting,” “storing,” “combining,” “dividing,” “executing,” or the like, refer to actions and processes (e.g., flowcharts 900, 1000, 1100, and 1200 of FIGS. 9, 10, 11, and 12, respectively) of an apparatus or computer system or similar electronic computing device or processor (e.g., the system 100 of FIG. 1). A computer system or similar electronic computing device manipulates and transforms data represented as physical (electronic) quantities within memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory (e.g., an SSD or NVMD) or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

In the discussion to follow, the following terminology is used. In general, terms such as “first,” “second,” and “third” are simply modifiers that are used to distinguish similar terms from one another; any exceptions will be made clear in the discussion.

The “first data encryption key” is the version of the data encryption key that is stored on the storage device. The first data encryption key may be wrapped, in which case it is referred to as the “wrapped version of the first data encryption key” or simply the “wrapped first data encryption key.”

The “second data encryption key” is the version of the data encryption key that is generated by the storage device and is used by the storage device to encrypt and decrypt data stored on the storage device.

An “intermediary data encryption key” is a version of the data encryption key that is between the wrapped version of the first data encryption key and the second data encryption key.

“First information” refers to information, such as a security key, that is received from a host system for the storage device. In an embodiment, the first information is used by the storage device to generate a first key encryption key. In other embodiments, the first information is a cryptographic quality key encryption key. This is discussed further below.

“Second information” refers to information that is received from a source other than the host system. That source is referred to as the “second source.” Depending on the embodiment, the second information includes a second key encryption key, a share of the second data encryption key, or a “third data encryption key.”

FIG. 1 is a block diagram showing elements of a storage system 100 upon which embodiments according to the present invention can be implemented. The system 100 may include elements other than those shown or described below.

In the example of FIG. 1, the system 100 includes a host system 120 that includes a central processing unit (CPU) 121, volatile memory 122, and non-volatile memory 123. The host system 120 may include elements other than those shown or described herein.

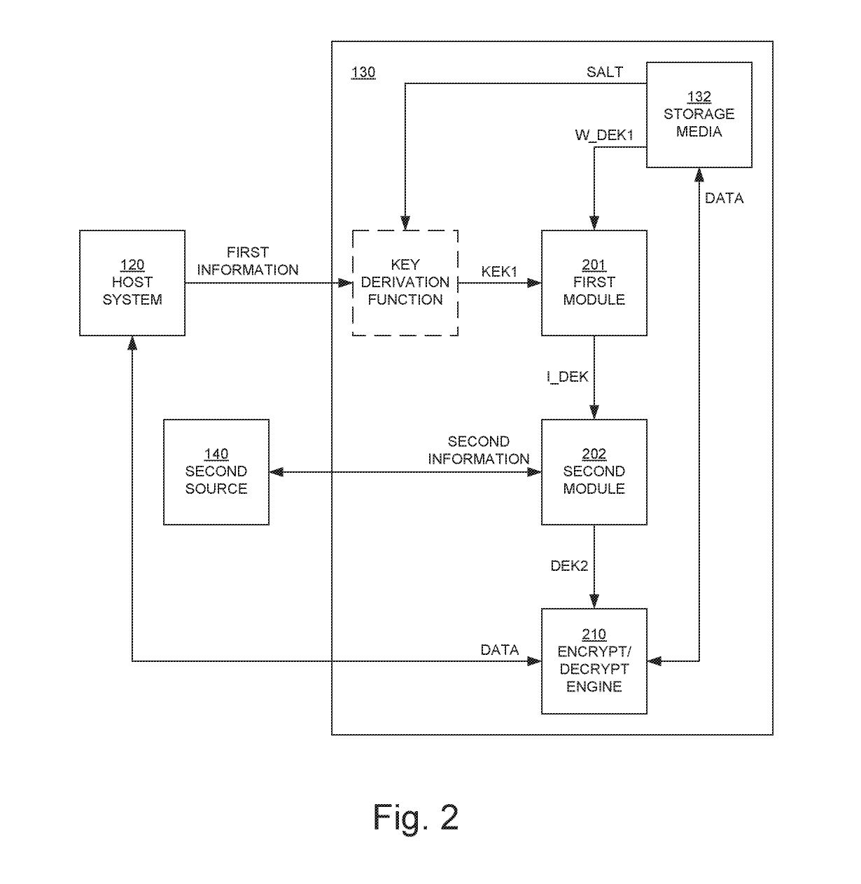

The host system 120 is coupled to or incorporates a number of storage devices 1 through N (1-N), exemplified by the storage device 130. The storage device 130 includes storage media 132. The storage media 132 may include one or more solid state drives or devices (SSDs), which may also be known as non-volatile memory devices (NVMDs) or as flash memory devices. The storage media may also or alternatively include one or more hard disk drives or devices (HDDs). The storage device 130 is further described in conjunction with FIGS. 2, 3, 4, and 5.

The storage system 100/host system 120 of FIG. 1 may or may not be a mobile device such as, but not limited to, a laptop computer. The system 100 can be part of a distributed or shared storage system (e.g., a data center or a network-attached storage (NAS) system or cluster) that provides data storage services to entities (e.g., customers) via a network (not shown). Those storage services may include the storage, management, and maintenance of data including large data sets commonly referred to as “big data.” The network may be a wired (including optical fiber) or wireless telecommunication or computer network including but not limited to, for example, an intranet, a wide area network (WAN), a local area network (LAN), a personal area network (PAN), a storage area network (SAN), or the Internet.

Data is encrypted and stored in the storage media 132 on the storage device 130. As will be described in greater detail below, in order for the stored data to be decrypted, embodiments according to the invention utilize at least two authentication factors. The first authentication factor may be, for example, a security key that is password-based. The storage device 130 is communicatively coupled to a source 140 (referred to herein as the second source), which is the source of a second authentication factor.

The second source 140 is separated or separable from the host system 120. Communications between the storage device 130 and the second source 140 do not pass through the host system 120. Specifically, the second source 140 and the host system 120 do not interface; there is no mechanism in the system 100 that allows communications between the storage device 130 and the second source 140 to be received or accessed by the host system 120. In the example of FIG. 1, the second source 140 is communicatively coupled to each of the storage devices 1-N. In an alternative implementation, there may be one or more second sources, each communicatively coupled to one or more of the storage devices.

FIG. 2 is a block diagram of a two-factor authentication storage device 130 in an embodiment according to the present invention. In the FIG. 2 embodiment, the storage device 130 includes a first module 201 and a second module 202.

The storage device 130 receives a first authentication factor (first information) from the host system 120. In an embodiment, the first information is or includes a security key such as a password. The security key is passed through a key derivation function such as, but not limited to, PBKDF2 (Password-Based Key Derivation Function 2) to derive a first key encryption key KEK1. The key derivation function may use random data (a salt) as an additional input in a well-known manner.

In another embodiment, the first information received from the host system 120 is or includes a cryptographic quality key encryption key. In other words, in such an embodiment, the first key encryption key KEK1 is received from the host system 120. In an embodiment, the host system 120 executes a key derivation function to derive the first key encryption key KEK1. Accordingly, the key derivation function may not be present on, or may be bypassed and not executed by, the storage device 130.

In general, the first key encryption key KEK1 is obtained from the first information received from the host system 120.

In an embodiment, the first module 201 accesses a wrapped first data encryption key W_DEK1 stored in the storage media 132 on the storage device 130. The first module 201 can unwrap the wrapped first data encryption key W_DEK1 with the first key encryption key KEK1 to generate an intermediary data encryption key I_DEK.

In another embodiment, the first data encryption key stored in the storage media 132 is not wrapped. Instead, for example, the intermediary data encryption key I_DEK is encrypted with a manufacturer- or device-specific key in a proprietary manner. For instance, the intermediary data encryption key I_DEK can be exclusive-ORed (XORed) with a hardcoded value of equal length, thereby obfuscating the intermediary data encryption key I_DEK in the storage media 132. The first information from the host system 120 thus could be or could include a password that is compared to the authorized, correct password stored in the storage media 132.

The second module 202 generates a second data encryption key DEK2 using the intermediary data encryption key I_DEK and a second authentication factor (second information) that is received from the second source 140. The second data encryption key DEK2 is used by the encryption/decryption engine 210 to encrypt and decrypt data stored in the storage media 132.

The second information stored on or provided by the second source 140 may itself be encrypted and/or wrapped. If so, it can be decrypted/unwrapped before it is sent to the storage device 130, or it can be decrypted/unwrapped by the storage device.

The second authentication factor (second information) provides an additional level of security to protect the stored data. As will be described further below, in embodiments according to the invention, the second authentication factor (second information) is only sent from the second source 140 to the storage device 130 if one or more conditions are satisfied. In those embodiments, the requirement that the condition(s) be satisfied provides yet another level of security to protect the stored data.

The second authentication factor (second information) may be subject to a policy that defines when and how the second authentication is to be used. For example, the same policy basis that governs the first authentication factor (the host system's security key) may be used, or a different policy can be used. Options range from presenting and checking the second authentication factor once at power-on to requiring it be presented and checked periodically (where “periodically” includes continuously). In the latter option, a hardware mechanism can be used to discard the second data encryption key DEK2 unless it is authenticated by the second authentication factor.

The storage media 132 or the storage device 130 can be logically or physically separated into multiple sections, with different access requirements for each section. For example, the first information required from the host system 120 and/or the second information required from the second source 140 may be different for each section. Thus, for example, a storage device or storage media with multiple sections may have one section accessible within one location, another section accessible within another location, and so on.

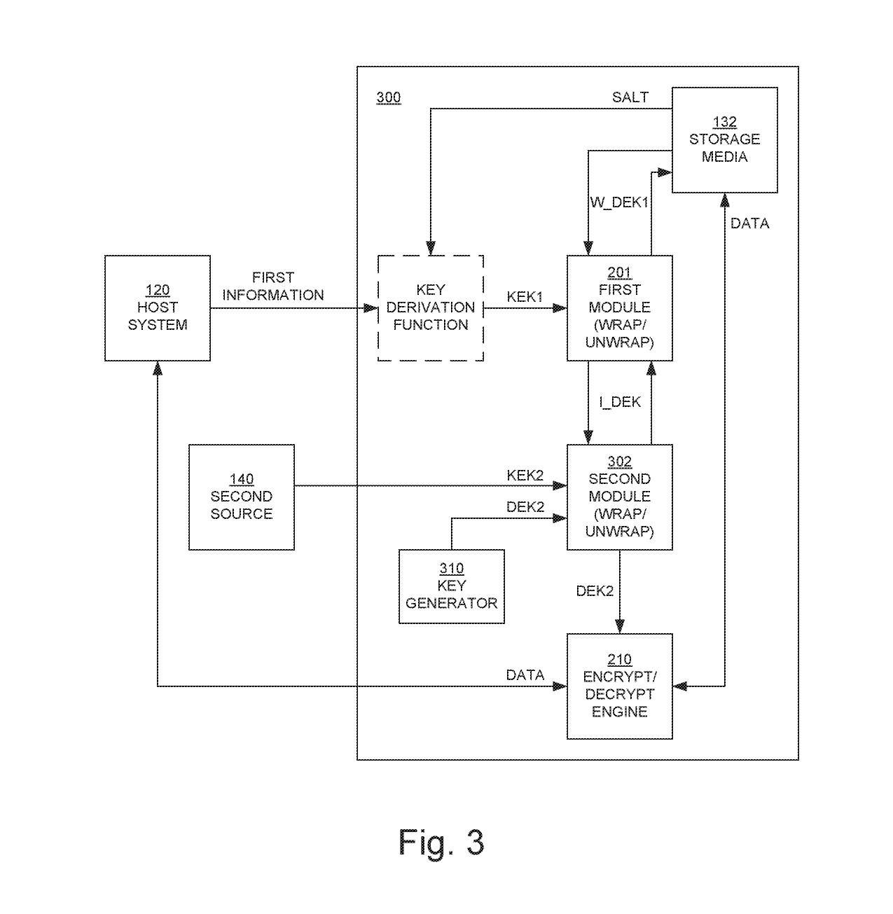

FIG. 3 is a block diagram of a two-factor authentication storage device 300 in an embodiment according to the present invention. The storage device 300 is an example of the storage device 130 of FIGS. 1 and 2.

As described above, the storage device 130 receives first information from the host system 120. In an embodiment, the first information includes a security key such as a password, which is passed through a key derivation function derive the first key encryption key KEK1. In another embodiment, the first information received from the host system 120 includes the first key encryption key KEK1. In an embodiment, the host system 120 executes a key derivation function to derive the first key encryption key KEK1. Accordingly, the key derivation function may not be present on, or may be bypassed and not executed by, the storage device 130.

In the FIG. 3 embodiment, the second data encryption key DEK2 is generated by a key generator 310 (e.g., a high-quality random number generator). The key generator 310 may be referred to herein as the third module of the storage device 130. The second data encryption key DEK2 can be used by the encryption/decryption engine 210 to encrypt data received from the host system 120.

In this embodiment, the second information received from the second source 140 includes a second key encryption key KEK2. To protect the second data encryption key DEK2, it is wrapped by the first key encryption key KEK1 and by the second key encryption key KEK2 to generate the first wrapped data encryption key W_DEK1. More specifically, in the FIG. 3 embodiment, the second module 302 wraps the second data encryption key DEK2 with the second key encryption key KEK2 using a key wrapping algorithm such as, but not limited to, the National Institute of Standards and Technology (NIST) AES (Advanced Encryption Standard) Key Wrap Specification. The output I_DEK of the second module 302 is input to the first module 201 and is wrapped by the first module with the first key encryption key KEK1 using a key wrapping algorithm such as, but not limited to, the NIST AES Key Wrap Specification to produce the wrapped first data encryption key W_DEK1. The wrapped first data encryption key W_DEK1 can then be stored in a reserved area of the storage media 132 on the storage device 300.

In this embodiment, to retrieve the second data encryption key DEK2 (in order to encrypt new data and/or decrypt stored data), the wrapped first data encryption key W_DEK1 is accessed from the reserved area of the storage media 132. The first module 201 unwraps the wrapped first data encryption key W_DEK1 using the first key encryption key KEK1. The output I_DEK of the first module 201 is input to the second module 302 and is unwrapped by the second module using the second key encryption key KEK2 to recover the second data encryption key DEK2. In an embodiment, as previously noted herein, the second key encryption key KEK2 is provided to the second module 302 by the second source 140 only if one or more conditions are all satisfied.

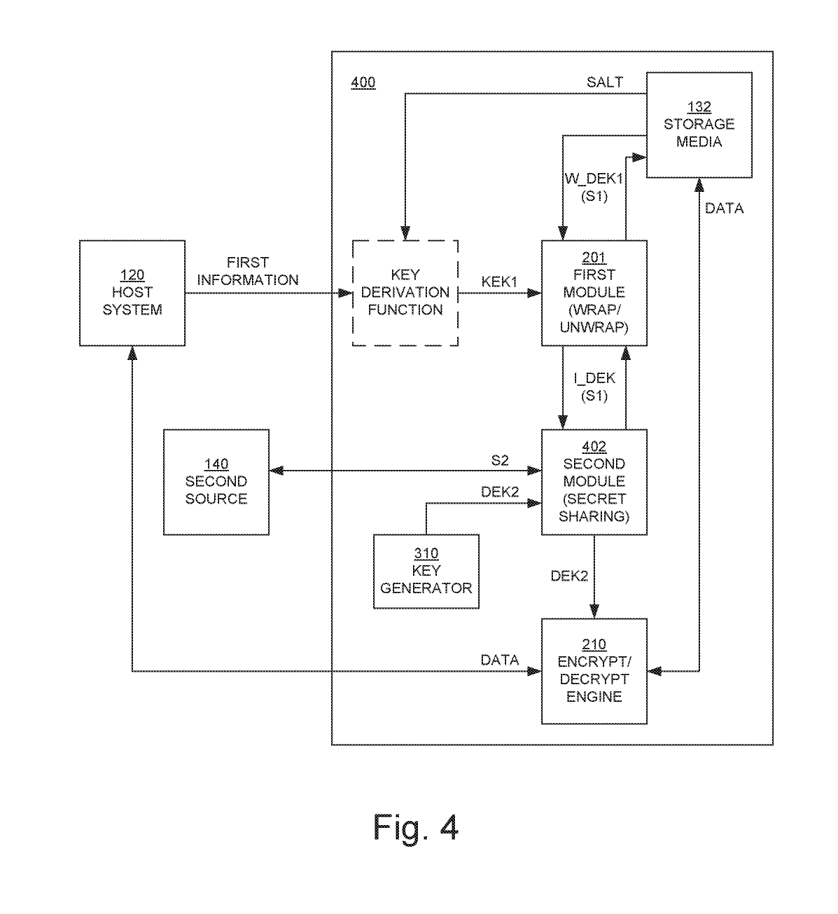

FIG. 4 is a block diagram of a two-factor authentication storage device 400 in another embodiment according to the present invention. The storage device 400 is an example of the storage device 130 of FIGS. 1 and 2.

As described above, the storage device 130 receives first information from the host system 120. In an embodiment, the first information includes a security key such as a password, which is passed through a key derivation function to derive the first key encryption key KEK1. In another embodiment, the first information received from the host system 120 includes the first key encryption key KEK1. In an embodiment, the host system 120 executes a key derivation function to derive the first key encryption key KEK1. Accordingly, the key derivation function may not be present on, or may be bypassed and not executed by, the storage device 130.

In the FIG. 4 embodiment, the second data encryption key DEK2 is generated by the key generator 310 and can be used by the encryption/decryption engine 210 to encrypt data received from the host system 120.

In the FIG. 4 embodiment, after the second data encryption key DEK2 is generated by the key generator 310, it is divided into a first share S1 and a second share S2 by the second module 402 using a secret sharing method. Secret sharing methods are well-known and include, for example, Shamir's scheme and Blakley's scheme. The second share S2 is stored on the second source 140. In this embodiment, the second information received from the second source 140 includes the second share S2 of the second data encryption key DEK2. The output I_DEK of the second module 402 (the second share S2) is wrapped with the first key encryption key KEK1 to generate the wrapped first data encryption key W_DEK1(S2), which can then be stored in a reserved area of the storage media 132 on the storage device 400.

In this embodiment, to retrieve the second data encryption key DEK2, the wrapped first data encryption key W_DEK1(S2) is accessed from the reserved area of the storage media 132. The first module 201 unwraps the wrapped first data encryption key W_DEK1(S2) using the first key encryption key KEK1. The output I_DEK (which is the first share S1) of the first module 201 is input to the second module 402. The second module 402 combines the second share S2 from the second source 140 and the first share S1 to produce the second data encryption key DEK2. In an embodiment, as previously noted herein, the second share S2 is provided to the second module 402 by the second source 140 only if one or more conditions are all satisfied.

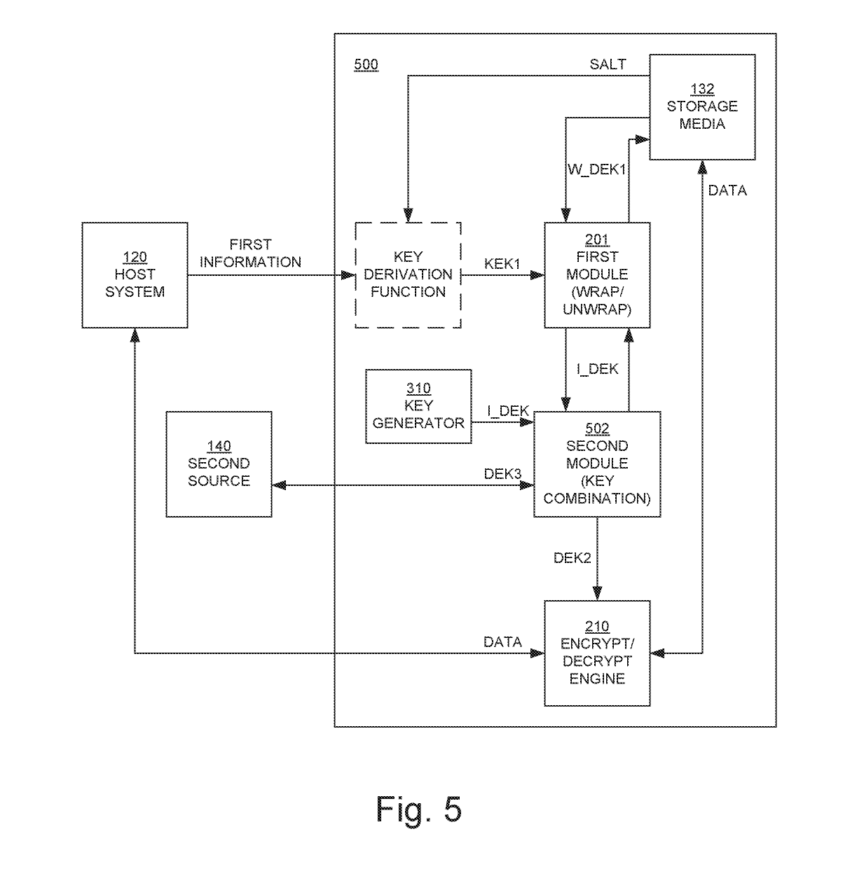

FIG. 5 is a block diagram of a two-factor authentication storage device 500 in another embodiment according to the present invention. The storage device 500 is another example of the storage device 130 of FIGS. 1 and 2.

As described above, the storage device 130 receives first information from the host system 120. In an embodiment, the first information includes a security key such as a password, which is passed through a key derivation function to derive the first key encryption key KEK1. In another embodiment, the first information received from the host system 120 includes the first key encryption key KEK1. In an embodiment, the host system 120 executes a key derivation function to derive the first key encryption key KEK1. Accordingly, the key derivation function may not be present on, or may be bypassed and not executed by, the storage device 130.

In the FIG. 5 embodiment, an intermediary data encryption key I_DEK is generated by the key generator 310. That is, in contrast to the embodiments described above, the data encryption key generated by the key generator 310 is not the key used to encrypt and decrypt data. In this embodiment, the second information received from the second source 140 includes a third data encryption key DEK3. The second module 502 uses key combination logic such as, but not limited to, a Hash-Based Message Authentication Code (HMAC) Key Derivation Function (HKDF), to combine the intermediary data encryption key I_DEK with the third data encryption key DEK3 to produce the second data encryption key DEK2 that can be used by the encryption/decryption engine 210 to encrypt data received from the host system 120.

In this embodiment, the first module 201 wraps the output I_DEK of the key generator 310 with the first key encryption key KEK1 to generate the wrapped first data encryption key W_DEK1. The wrapped first data encryption key W_DEK1 can then be stored in a reserved area of the storage media 132 on the storage device 500.

In this embodiment, to retrieve the second data encryption key DEK2, the wrapped first data encryption key W_DEK1 is accessed from the reserved area of the storage media 132. The first module 201 unwraps the wrapped first data encryption key W_DEK1 using the first key encryption key KEK1. The output I_DEK of the first module 201 is input to the second module 502. The second module 502 combines the output of the first module 201 with the third data encryption key DEK3 to generate the second data encryption key DEK2. In an embodiment, as previously noted herein, the third data encryption key DEK3 is provided by the second source 140 to the second module 502 only if one or more conditions are all satisfied.

The embodiments just described are particularly advantageous when keys provided by the second source 140 such as the second key encryption key KEK2 (FIG. 3), the second data encryption key DEK2 produced by combining the shares S1 and S2 (FIG. 4), and the third data encryption key DEK3 (FIG. 5) are of cryptographic quality. Furthermore, security of the data-at-rest is improved when the second source 140 is not accessible to firmware on the storage device 130. This ensures that the information in the second source 140 is not at risk of exposure even if the firmware on the storage device 130 is compromised. Preventing the firmware on the storage device 130 from viewing or modifying the second authentication factor (the second information) ensures that the firmware, should it be compromised, cannot be used to decrypt the stored data.

As mentioned above, in an embodiment, the second authentication factor (the second information from the second source 140) is provided to the storage device 130 only if one or more conditions are satisfied. The condition may be based on, for example, the location of the storage device 130, the presence of a particular physical object, or the environment of the storage device, or a combination of such conditions. In general, the conditions guard against removal of the storage device 130 from the host system 120 or data center; if the storage device is removed, then one or more of the conditions cannot be satisfied. The conditions can also be used to prevent operation of or access to data on storage devices on mobile devices such as laptops that have been stolen, for example. If the one or more conditions are not all satisfied, then the second information is not sent to the storage device 130, the second data encryption key cannot be generated, and the stored data cannot be decrypted.

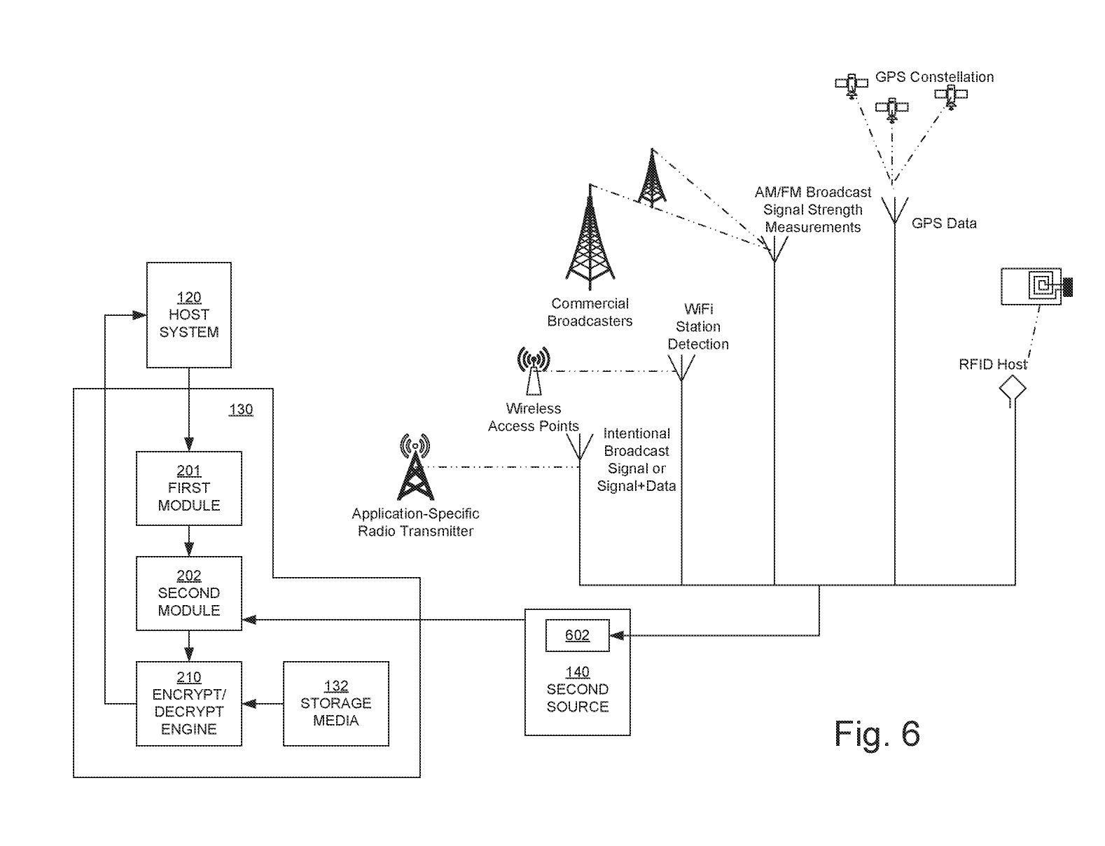

FIG. 6 is a block diagram illustrating how condition(s) for authenticating the location of the storage device 130 can be established and applied through the use of location awareness and detection (e.g., using geolocation and/or geofencing) in embodiments according to the invention. In these embodiments, the second source 140 does not provide the second information (second authentication factor) to the storage device 130 if one or more location-based conditions are not satisfied. If the current location for the storage device 130 does not match the device's configured state within some tolerance, then the second information is not given to the storage device and the stored data remains secure because it cannot be decrypted. In essence, in the FIG. 6 embodiments, the security of the data stored on a self-encrypting storage device such as the storage device 130 is enhanced by including location information as a necessary input to the data encryption and decryption processes.

In the embodiment of FIG. 6, the second source 140 includes a module 602 that receives information from one or more of the location awareness and detection mechanisms and can compare that information against a set of geolocation/geofencing parameters. If the information matches the parameters within a prescribed tolerance, then this provides an indication that the storage device 130 is at its specified location or within a prescribed distance of its specified location, e.g., it is proximate to the host system 120 or in the data center, or is at or within a prescribed distance of an authorized location. In the latter case, a mobile device such as a laptop may be used at home and in the office, and so both locations are designated as authorized locations.

Verification of the location of the storage device 130 through geolocation and/or geofencing may be performed when the storage device is powered on and remain valid for the duration of the power-on time of the storage device, or it may be repeated at periodic intervals. Advantages to the former approach are that it reduces exposure to the possibility of unreliability and can save power, while an advantage to the latter approach is that it reduces the risk of tampering.

The second information/authentication factor may be information that is stored on the second source 140 or it may be information that is derived from the mechanism used for location awareness and detection. In the embodiment of FIG. 4, the second information (the first share of the S1 of the second data encryption key DEK2) is stored on the second source 140. In the embodiments of FIGS. 3 and 5, the second key encryption key KEK2 and the third data encryption key DEK3 can be values that are generated by, for example, a random number generator or they can be values that are derived from location-based information; in either case, those values can either be generated ahead-of-time and stored on the second source 140 or generated on-the-fly when requested by the storage device 130. If the values are stored on the second source 140, they can be encrypted or wrapped.

As illustrated by FIG. 6, location awareness and detection based on geolocation and/or geofencing can be implemented using one or more mechanisms or methods such as, but not limited to: radio frequency (RF) signal measurements from fixed sources such as wireless (e.g., WiFi or Bluetooth) access points, cell phone towers, radio (e.g., AM or FM) broadcasters, and dedicated beacons; RF reception of a specific beacon, a synchronized clock signal, or transmitter operated at the data center site; magnetic field characterization using, for example, a digital compass; geotagging with RFID or a smart card; and direct position measurement using GPS (the Global Positioning System) or a similar positioning system.

For a GPS-based authentication mechanism, operation of the storage device 130 can be allowed in certain geographical regions, or operation within a certain distance from a centralized point can be allowed, with the data stored on the storage device remaining inaccessible if the storage device is outside those regions or outside the permitted distance from the centralized point.

For authentication mechanisms based on RF measurements, such as the use of broadcast signals, a number N of local broadcasters in a certain frequency band can be identified, and a signal of a certain threshold strength would need to be received from some number M of those broadcasters (M less than N) in order for data to be accessed from the storage device 130. This allows for outages while effectively locking the storage device's location at a point where the RF fields from the various broadcasters are within a specified tolerance of a measured baseline, and will allow access to the stored data if there is a change to the number of broadcasters. Similarly, signals from M of N fixed sources (e.g., WiFi access points or dedicated beacons) would be required for data to be accessed from the storage device 130, so that access to stored data is still possible if there is a change in configuration at the data center.

For authentication mechanisms based on a device such as an RFID or a smart card, the device would need to be within range of the storage device 130 in order for the stored data to be accessed. Also, for example, an employee badge could incorporate the RFID or smart card, and a number (e.g., an employee badge number) can be built into the RFID or smart card and used as a seed to hash the second information/authentication factor such as the second key encryption key KEK2 and the third data encryption key DEK3. Authentication mechanisms based on an RFID or smart card or the like can be particularly useful for storage devices housed in mobile systems.

For authentication mechanisms that utilize a beacon, a synchronized clock signal, or transmitter operated at the data center site, the storage device 130 would need to receive a signal on a periodic basis from those types of devices in order for the stored data to be accessed.

In the event that maintenance activity will significantly modify the location of the storage device 130 or the location awareness and detection mechanisms used to determine the location of the storage device for authentication purposes, a second security key provided by the host system 120 can be used to “re-home” the storage device. To re-home the storage device 130, the set of geolocation/geofencing parameters and associated tolerances can be updated to account for any changes introduced by the maintenance activity.

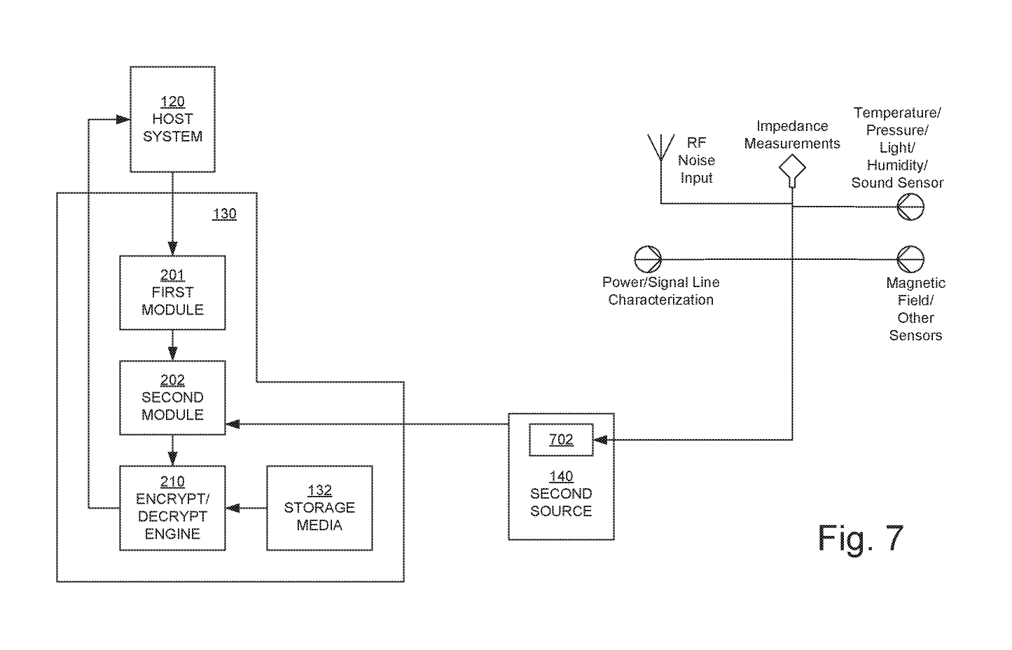

FIG. 7 is a block diagram illustrating how condition(s) for authenticating the location of the storage device 130 can be established and applied through the use of passive environmental characterization in embodiments according to the invention. In these embodiments, the second source 140 does not provide the second information (second authentication factor) to the storage device 130 if the operating environment of the storage device does not match the device's configured state within some tolerance. If one or more of the environment-based conditions are not satisfied, then the second information is not given to the storage device and the stored data remains secure because it cannot be decrypted. In essence, in the FIG. 7 embodiments, the security of the data stored on a self-encrypting storage device such as the storage device 130 is enhanced by including environmental information as a necessary input to the data encryption and decryption processes.

In the embodiment of FIG. 7, the second source 140 includes a module 702 that monitors and measures characteristics of the operating environment of the storage device 130 and compares the measured environment against a set of environmental parameters. If measurements match the parameters within a prescribed tolerance, then this provides an indication that the storage device 130 is at its specified location or within a prescribed distance of its specified location, e.g., it is proximate to the host system 120 or in the data center, or is at or within a prescribed distance of an authorized location.

Verification of the location of the storage device 130 through environmental monitoring may be performed when the storage device is powered on and remain valid for the duration of the power-on time of the storage device, or it may be repeated at periodic intervals. If performed at periodic intervals, then the measured environment needs to satisfy the established environmental parameters at each interval in order for the second information to be provided to the storage device 130. Advantages to the former approach are that it reduces exposure to the effects of short-term environmental transients, while an advantage to the latter approach is that it reduces the risk of tampering. A moving average can be used for long-term transients; if a change in a monitored characteristic changes too fast, then the second information is not given to the storage device 130.

In a manner similar to that discussed above with regard to location-based conditions, the second information/authentication factor may be information that is stored on the second source 140 or it may be information that is derived from the mechanism used for environmental characterization. Values that are derived from environment-based information can either be generated ahead-of-time and stored on the second source 140 or generated on-the-fly when requested by the storage device 130. If the values are stored on the second source 140, they can be encrypted or wrapped.

As illustrated by FIG. 7, location awareness and detection based on environmental characteristics can be implemented by monitoring and measuring characteristics such as, but not limited to: power input and power supply; RF noise; temperature and humidity; visible, ultraviolet, and infrared light; sound; host interface baseband signal; magnetic field; and impedance of connected components or the surrounding enclosure.

A baseline and a baseline change threshold can be established in the operating environment. Optionally, a tolerance can be specified for each characteristic. As another option, a moving average of the monitored characteristics can be used for long-term transients as mentioned above.

In the event that maintenance activity will significantly modify the operating environment of the storage device 130, a second security key provided by the host system 120 can be used to characterize the new operating environment or to temporarily disable the use of the second authentication factor until the configured operating environment is restored. Optionally, a warning may be signaled to an operator if the environment is approaching a level that is outside the permitted tolerances so that the environmental parameters can be preemptively characterized to match the current (new) environment.

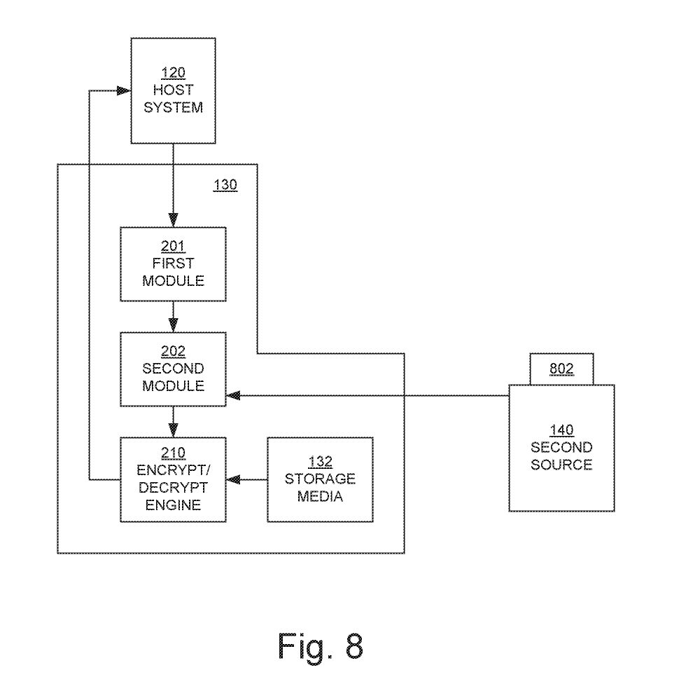

FIG. 8 is a block diagram illustrating how condition(s) for authenticating the location of the storage device 130 can be established and applied through the use of a physical component or object in embodiments according to the invention. In these embodiments, the second source 140 does not provide the second information (second authentication factor) to the storage device 130 if one or more object-based conditions are not satisfied. If the required physical component or object is not present, then the second information is not given to the storage device and the stored data remains secure because it cannot be decrypted. The required object may be associated with a particular trusted or authorized person. Thus, in essence, in the FIG. 8 embodiments, the security of the data stored on a self-encrypting storage device such as the storage device 130 is enhanced by requiring both the host security key and the presence of a trusted object or person.

In the embodiment of FIG. 8, a physical object or component 802 is physically attached to (e.g., plugged into) the second source 140 or can interface with the second source via a wired or wireless connection. Alternatively, the second source 140 is used as the object 802. The object 802 can include information that uniquely identifies it as the required authentication object. Alternatively, the object 802 can include the second information/authentication factor such as the first share of the S1 of the second data encryption key DEK2 (FIG. 4), the second key encryption key KEK2 (FIG. 3), or the third data encryption key DEK3 (FIG. 5). The object 802 can provide a key whenever data is to be stored on or retrieved from the storage device 130. Without the presence of the object 802, the data would not be able to be decrypted.

The presence of the object 802 for authentication purposes can be required all of the time, periodically, once at power-on, or on a per-session basis. In the first case, the object 802 can transmit the second information/authentication factor directly to the appropriate modules of the storage device 130, while in the latter three cases, that information can be cached in the second module 202 until power-off or the session expires.

The object 802 of FIG. 8 can be implemented using one or more mechanisms such as, but not limited to: a smart card; a Universal Serial Bus (USB) key or token; a code generator; a Trusted Platform Module (TPM) chip; or an interposer device that is placed between the storage device 130 and the host system 120.

A code generator can communicate a key to the second source 140 or the storage device 130 via a vendor-unique mechanism.

A TPM chip can be inserted into the drive bay in which the storage device 130 is mounted. The TPM chip can be a non-removable component of the drive bay such that removal of the storage device 130 from the drive bay separates the storage device from the TPM chip. The TPM chip can be electrically interfaced to the storage device 130 via, for example, extra or unused interface pins or by multiplexing with an existing signal.

An interposer is, in general, an object that is located between the storage device 130 and the host system 120. The interposer is a non-removable component that can be integrated with the host system 120 or permanently attached to the host system, without requiring modification to or redesign of the host system. The interposer can contain a volatile key that is erased if power is removed from the interposer. The interposer can contain a TPM chip, for example.

The various authentication mechanisms and conditions described above in conjunction with FIGS. 6, 7, and 8 can be used singly or in any combination.

FIGS. 9, 10, 11, and 12 are flowcharts 900, 1000, 1100, and 1200, respectively, illustrating examples of operations for protecting data in a storage device in embodiments according to the present invention.

In block 902 of FIG. 9, with reference also to FIG. 2, a first data encryption key W_DEK1 that is stored in storage media 132 on the storage device 130 is accessed. In an embodiment, the first data encryption key W_DEK1 is wrapped as previously described herein. In another embodiment, the first data encryption key W_DEK1 is not wrapped.

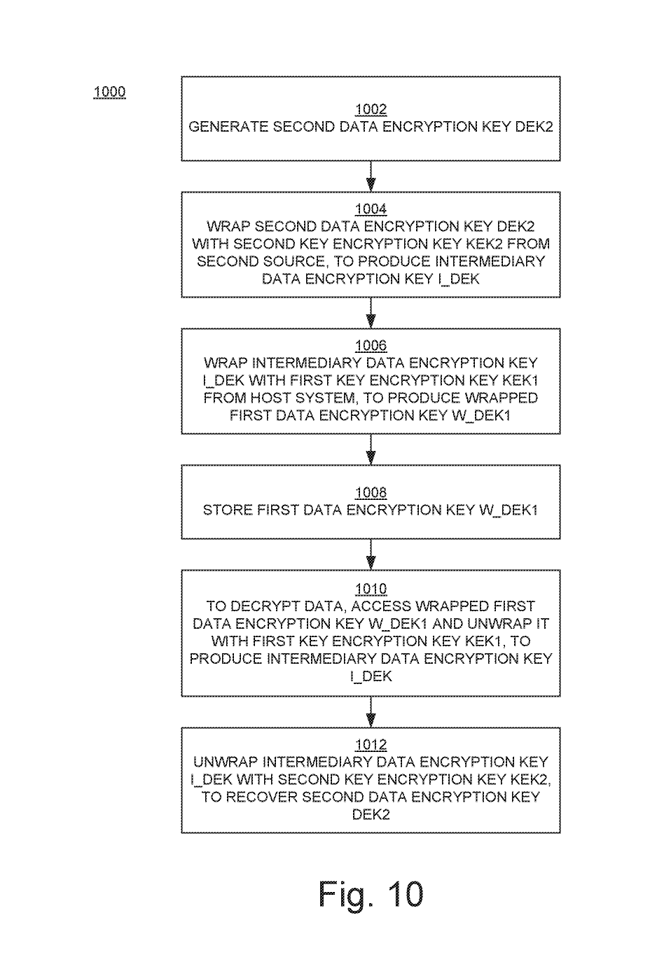

In block 904, a second data encryption key DEK2 that can be used to decrypt data stored in the storage media 132 on the storage device 130 is generated using: the first data encryption key W_DEK1; a first key encryption key KEK1 obtained from the first information received from the host system 120; and second information (a second authentication factor) that is received from the second source 140. Additional information with regard to the operations of block 904 is described below, in conjunction with FIGS. 10, 11, and 12.

In block 906, in an embodiment, the second information is sent from the second source 140 to the storage device 130 in response to at least one condition being satisfied. The at least one condition can be one or more of the following (see the discussions of FIGS. 6, 7, and 8 above): indication that a specified physical object is attached to the storage device; indication that a specified physical object is within a prescribed distance of the storage device; indication that the storage device is at a specified physical location; indication that the storage device is within a prescribed distance of a specified physical location; and indication that the storage device's operating environment matches an environmental condition within a specified tolerance.

With reference now to FIGS. 3 and 10, in block 1002, the second data encryption key DEK2 is generated with the key generator 310 executed by the storage device 130.

In block 1004, the second data encryption key DEK2 is wrapped with the second key encryption key KEK2 to produce an intermediary version of the data encryption key, I_DEK. The second key encryption key KEK2 is received from the second source 140 and constitutes the second information mentioned in block 904 of FIG. 9.

In block 1006 of FIG. 10, in an embodiment, the intermediary data encryption key I_DEK is wrapped with the first key encryption key KEK1 to generate a wrapped version of the first data encryption key W_DEK1.

In block 1008, in an embodiment, the wrapped first data encryption key W_DEK1 is stored in the storage media 132 on the storage device 130.

In block 1010, to decrypt stored data in an embodiment, the wrapped first data encryption key W_DEK1 is read from the storage media 132 and unwrapped with the first key encryption key KEK1 to generate the intermediary data encryption key I_DEK, which is a wrapped version of the second data encryption key DEK2.

In block 1012, the intermediary data encryption key I_DEK is unwrapped using the second key encryption key KEK2 (the second information received from the second source 140) to recover the second data encryption key DEK2, which can be used to decrypt the stored data.

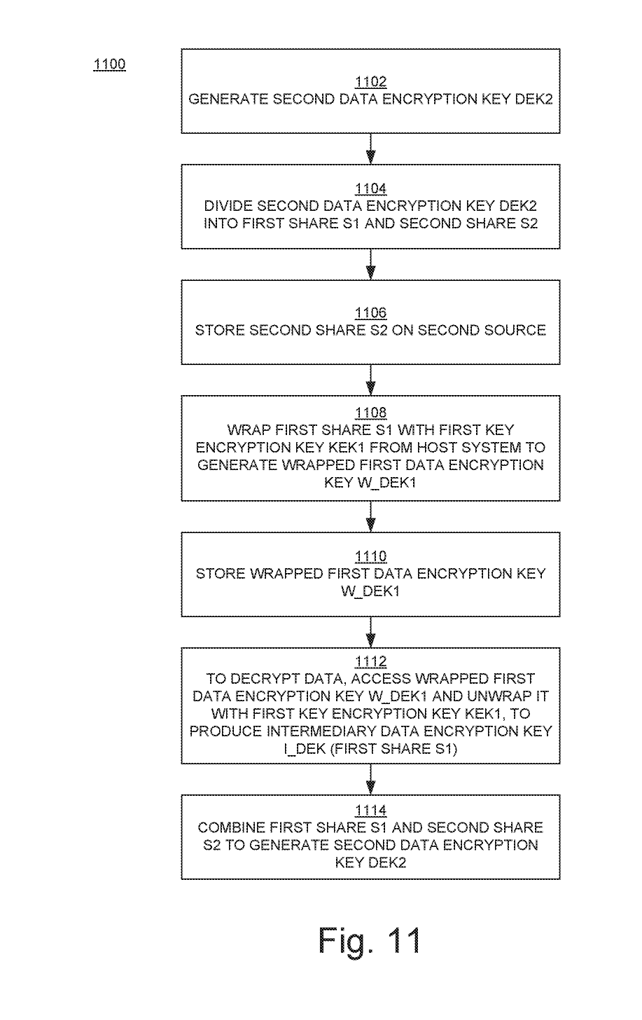

With reference now to FIGS. 4 and 11, in block 1102, the second data encryption key DEK2 is generated with the key generator 310.

In block 1104, the second data encryption key DEK2 is divided into the first share S1 and the second share S2.

In block 1106, the second share S2 is stored on the second source 140. The second share S2 constitutes the second information mentioned in block 904 of FIG. 9.

In block 1108 of FIG. 11, in an embodiment, the first share S1 is wrapped with the first key encryption key KEK1 to generate a wrapped version of the first data encryption key W_DEK1.

In block 1110, in an embodiment, the wrapped first data encryption key W_DEK1 is stored in the storage media 132 on the storage device 130.

In block 1112, to decrypt stored data in an embodiment, the wrapped first data encryption key W_DEK1 is read from the storage media 132 and unwrapped with the first key encryption key KEK1 to generate the intermediary data encryption key I_DEK, which is the first share S1 of the second data encryption key DEK2.

In block 1114, the second share S2 (the second information received from the second source 140) and the first share S1 are combined to generate the second data encryption key DEK2, which can be used to decrypt the stored data.

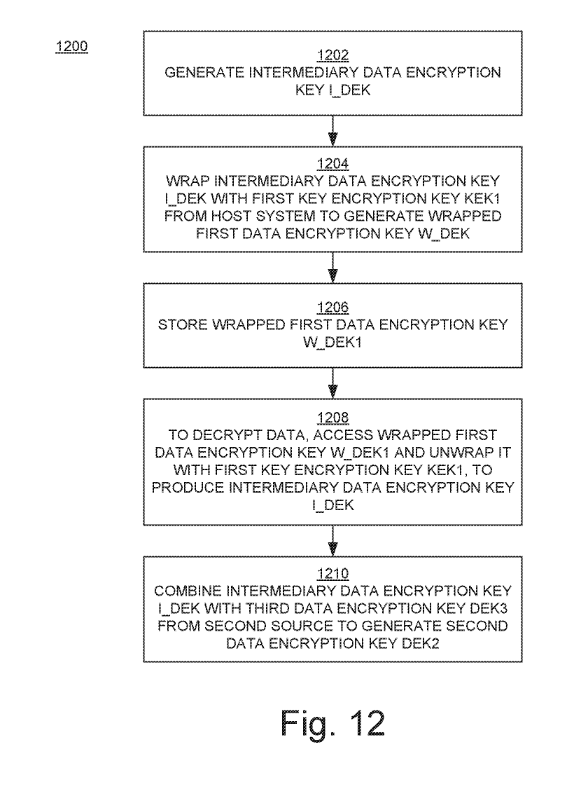

With reference now to FIGS. 5 and 12, in block 1202, the intermediary data encryption key I_DEK is generated with the key generator 310.

In block 1204, in an embodiment, the intermediary data encryption key I_DEK is wrapped with the first key encryption key KEK1 to generate a wrapped version of the first data encryption key W_DEK1.

In block 1206, in an embodiment, the wrapped first data encryption key W_DEK1 is stored in the storage media 132 on the storage device 130.

In block 1208, to decrypt stored data in an embodiment, the wrapped first data encryption key W_DEK1 is read from the storage media 132 and unwrapped with the first key encryption key KEK1 to generate the intermediary data encryption key I_DEK.

In block 1210, the intermediary data encryption key I_DEK is combined with the third data encryption key DEK3 to generate the second data encryption key DEK2, which can be used to decrypt the stored data. The third data encryption key DEK3 is received from the second source 140 and constitutes the second information mentioned in block 904 of FIG. 9.

Thus, embodiments according to the present invention enhance security measures for protecting data-at-rest in scenarios where the host system becomes compromised and has its security keys extracted by an attacker, or in scenarios where the storage device is compromised by malicious firmware that captures and stores the host system's security keys, and then the storage device is removed from the host system or data center. Embodiments according to the invention guard against these scenarios using a second authentication factor that provides an added level of security against inside as well as outside attacks. In other embodiments, the second authentication factor is not given to the storage device if one or more conditions are not satisfied, providing yet another level of security.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., storage as a service, software as a service, platform as a service, infrastructure as a service, etc.) may be accessible through a Web browser or other remote interface. Various functions described herein may be provided through a remote desktop environment or any other cloud-based computing environment.

Although the subject matter has been described in language specific to structural features and/or methodological acts, it is to be understood that the subject matter defined in the disclosure is not necessarily limited to the specific features or acts described above. Rather, the specific features and acts described above are disclosed as example forms of implementing the disclosure.

Embodiments according to the invention are thus described. While the present disclosure has been described in particular embodiments, it should be appreciated that the invention should not be construed as limited by such embodiments, but rather construed according to the following claims.

What is claimed is:

1. In a storage device, a method of protecting data stored on the storage device, the method comprising:
accessing a first data encryption key stored in storage media on the storage device; and
generating a second data encryption key that is used to encrypt and decrypt data stored in the storage media on the storage device using: the first data encryption key, a first key encryption key obtained from first information received from a host system that is communicatively coupled to the storage device, and second information that is received from a source other than the host system and that is communicatively coupled to the storage device.

2. The method of claim 1, wherein the second information is sent from the source to the storage device in response to a condition being satisfied.

3. The method of claim 2, wherein the condition is checked periodically and wherein the method further comprises discarding the second data encryption key unless the condition is satisfied.

4. The method of claim 2, wherein the condition is selected from the group consisting of: indication that a specified physical object is attached to the storage device; indication that a specified physical object is within a prescribed distance of the storage device; indication that the storage device is at a specified physical location; indication that the storage device is within a prescribed distance of a specified physical location; and indication that the storage device's operating environment matches an environmental condition within a specified tolerance.

5. The method of claim 1, wherein the second information comprises a second key encryption key and wherein said generating comprises:
unwrapping a wrapped version of the first data encryption key with the first key encryption key to generate an intermediary data encryption key comprising a wrapped version of the second data encryption key; and
unwrapping the intermediary data encryption key using the second key encryption key to generate the second data encryption key.

6. The method of claim 5, further comprising:
generating the second data encryption key with a key generator executed by the storage device, wherein the second data encryption key is used to encrypt data written to storage media on the storage device;
wrapping the second data encryption key with the second key encryption key and with the first key encryption key to generate the wrapped version of the first data encryption key; and
storing the wrapped version of the first data encryption key in the storage media on the storage device.

7. The method of claim 1, wherein said generating comprises:
unwrapping a wrapped version of the first data encryption key with the first key encryption key to generate an intermediary data encryption key comprising a first share of the second data encryption key, wherein the second information comprises a second share of the second data encryption key; and
combining the first share and the second share to generate the second data encryption key.

8. The method of claim 7, further comprising:
generating the second data encryption key with a key generator executed by the storage device, wherein the second data encryption key is used to encrypt data written to storage media on the storage device;
dividing the second data encryption key into the first share and the second share;
storing the second share on the source;
wrapping the first share with the first key encryption key to generate the wrapped version of the first data encryption key; and
storing the wrapped version of the first data encryption key in the storage media on the storage device.

9. The method of claim 1, wherein the second information comprises a third data encryption key and wherein said generating comprises:
unwrapping a wrapped version of the first data encryption key with the first key encryption key to generate an intermediary data encryption key; and
combining the intermediary data encryption key and the third data encryption key to generate the second data encryption key.

10. The method of claim 9, further comprising:
generating the intermediary data encryption key with a key generator executed by the storage device;
wrapping the intermediary data encryption key with the first key encryption key to generate the wrapped version of the first data encryption key; and
storing the wrapped version of the first data encryption key in the storage media on the storage device.

11. A system, comprising:
a host comprising:
a processor; and
memory coupled to the processor; and
a storage device coupled to the host;
the storage device configured to access a first data encryption key stored in the storage media and to generate an intermediary data encryption key using the first data encryption key and a first key encryption key that is obtained from first information received from the host; and
the storage device further configured to generate a second data encryption key using the intermediary data encryption key and second information that is received from a source that is communicatively coupled to the storage device and that that bypasses the host when communicating with the storage device, wherein the second data encryption key is used to decrypt data stored in the storage media on the storage device.

12. The system of claim 11, wherein the second information is sent from the source to the storage device in response to a condition being satisfied, wherein the condition is selected from the group consisting of: indication that a specified physical object is attached to the storage device; indication that a specified physical object is within a prescribed distance of the storage device; indication that the storage device is at a specified physical location; indication that the storage device is within a prescribed distance of a specified physical location; and indication that the storage device's operating environment matches an environmental condition within a specified tolerance.

13. The system of claim 11, wherein the second information comprises a second key encryption key and the intermediary data encryption key comprises a wrapped version of the second data encryption key, wherein the storage device is configured to unwrap the intermediary data encryption key using the second key encryption key to generate the second data encryption key;
wherein the storage device is further configured to generate the second data encryption key, to wrap the second data encryption key with the second key encryption key to generate the intermediary data encryption key, and to wrap the intermediary data encryption key with the first key encryption key to generate a wrapped version of the first data encryption key, wherein the wrapped version of the first data encryption key is unwrapped with the first key encryption key to generate the intermediary data encryption key.

14. The system of claim 11, wherein the intermediary data encryption key comprises a first share of the second data encryption key and the second information comprises a second share of the second data encryption key, wherein the storage device is further configured to combine the first share and the second share to generate the second data encryption key;
wherein the storage device is further configured to generate the second data encryption key, to divide the second data encryption key into the first share and the second share, and to wrap the first share with the first key encryption key to generate a wrapped version of the first data encryption key, wherein the wrapped version of the first data encryption key is unwrapped with the first key encryption key to generate the intermediary data encryption key.

15. The system of claim 11, wherein the second information comprises a third data encryption key, wherein the storage device is further configured to combine the intermediary data encryption key and the third data encryption key to generate the second data encryption key;
wherein the storage device is further configured to generate the second data encryption key and to wrap the second data encryption key with the first key encryption key to generate a wrapped version of the first data encryption key, wherein the wrapped version of the first data encryption key is unwrapped with the first key encryption key to generate the intermediary data encryption key.

16. A storage device, comprising:
a first module;
a second module coupled to the first module; and
storage media coupled to the first module;
the first module operable for accessing a first data encryption key stored in the storage media and for generating an intermediary data encryption key using the first data encryption key and a first key encryption key that is obtained from first information received from a host system that is communicatively coupled to the storage device; and
the second module operable for generating a second data encryption key using the intermediary data encryption key and second information that is received from a source that is communicatively coupled to the storage device and that bypasses the host system when communicating with the storage device, wherein the second data encryption key is used to decrypt data stored in the storage media on the storage device.

17. The storage device of claim 16, wherein the second information is sent from the source to the storage device in response to a condition being satisfied, and wherein the condition is selected from the group consisting of: indication that a specified physical object is attached to the storage device; indication that a specified physical object is within a prescribed distance of the storage device; indication that the storage device is at a specified physical location; indication that the storage device is within a prescribed distance of a specified physical location; and indication that the storage device's operating environment matches an environmental condition within a specified tolerance.

18. The storage device of claim 16, wherein the second information comprises a second key encryption key and wherein the intermediary data encryption key comprises a wrapped version of the second data encryption key, wherein the second module is operable for unwrapping the intermediary data encryption key using the second key encryption key to recover the second data encryption key;
wherein the storage device further comprises a third module coupled to the second module and operable for generating the second data encryption key, wherein the second module is further operable for wrapping the second data encryption key with the second key encryption key to generate the intermediary data encryption key and wherein the first module is further operable for wrapping the intermediary data encryption key with the first key encryption key to generate a wrapped version of the first data encryption key, wherein the wrapped version of the first data encryption key is unwrapped with the first key encryption key to generate the intermediary data encryption key.

19. The storage device of claim 16, wherein the second information comprises a first share of the second data encryption key and wherein the intermediary data encryption key comprises a second share of the second data encryption key, wherein the second module is further operable for combining the first share and the second share to recover the second data encryption key;
wherein the storage device further comprises a third module coupled to the second module and operable for generating the second data encryption key, wherein the second module is further operable for dividing the second data encryption key into the first share and the second share, and wherein the first module is further operable for wrapping the second share with the first key encryption key to generate a wrapped version of wrapped first data encryption key, wherein the wrapped version of the first data encryption key is unwrapped with the first key encryption key to generate the intermediary data encryption key.

20. The storage device of claim 16, wherein the second information comprises a third data encryption key, wherein the second module is further operable for combining the intermediary data encryption key and the third data encryption key to generate the second data encryption key;
wherein the storage device further comprises a third module coupled to the second module and operable for generating the second data encryption key, wherein the first module is further operable for wrapping the intermediary data encryption key with the first key encryption key to generate a wrapped version of the first data encryption key, wherein the wrapped version of the first data encryption key is unwrapped with the first key encryption key to generate the intermediary data encryption key.
